(19) United States
(12) Patent Application Publication
(10) Pub. No.: US 2004/0172268 A1
(43) Pub. Date: Sep. 2, 2004

(54) METHOD FOR CREATING A HUMAN RESOURCES AND BENEFITS WEBSITE

(76) Inventors: Tresia Ann Franklin, Kansas City, MO (US); Mark David Welker, Kansas City, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/707,799

(22) Filed: Jan. 13, 2004

Related U.S. Application Data
(60) Provisional application No. 60/439,958, filed on Jan. 14, 2003.

(51) Int. Cl. G06F 17/60

(52) U.S. Cl. 705/1

(57) ABSTRACT

An apparatus and method, referred to as MyHROnline, for providing employers with an easy, online way to create information about Benefits, Policies and Procedures and to make Benefit and Policy/procedures information available to their employees or others to whom they wish to offer access, such as job seekers (together, those will be referred to as “Employees”). You are not limited to the pre-programmed information. The wizard allows you to edit the pre-programmed information and/or create your own information about any benefit or policy that you would like and place the information on an interactive web site accessible by the employees. The site is as expansive or limited as you desire. MyHROnline lets you provide the information you want to your employees, then simply click “go live” to make the information available to your workforce. The site is fully hosted by the myHROnline server site and is available to your workforce 24/7.

### CROSS REFERENCE TO RELATED APPLICATIONS

This application claims the benefit of U.S. Provisional Application No. 60/439,958 filed on Jan. 14, 2003.

### BACKGROUND OF INVENTION

1. Field of Invention

This invention relates generally to methods for providing employee benefit and policy information and, more particularly, to a method of providing online communication of employee benefit and policy information via an “online brochure”.

2. Background Art

There are various challenges with traditional communication to employees regarding employee benefits and policies/procedures. One challenge is, employers frequently desire to make changes to a benefit program or policy/procedure due to various factors including the ever changing healthcare industry, employment laws and ever changing tax laws. The problem with providing printed communication is that it becomes out of date right after it is printed. Employees often have specific questions and are looking for answers. Traditional communication with pages of text requires employees to read about what they don't want to know in order to get to the info they want. Traditional communication is not usually presented in a brief, tactical and actionable manner. Another challenge is the nearly impossible task an employer has to keep all the information organized for easy access.

The employer or a member of the benefit department's staff will often find that the same questions are being asked frequently, because the answer is not readily accessible to the employee. The result is that programs are overlooked or misunderstood.

With existing methods there is no way to easily update and customize information for a given employer. Existing methods do not provide any type of automated interactive system. Adequate tools are not available to the employer to prevent a lot of manual re-creation of benefits and policy/procedure information.

Once the employer has recreated the information, then dissemination of the information to the employee becomes the problem. Updating and disseminating information using current methods are not only time consuming but are also costly. Also, employers will sometimes rely heavily on outside consultants for updating and disseminating benefit information. Also with current methods employees have difficulty accessing information without contacting an individual in the benefits or Human Resources department.

Current systems do not provide easy access to information for the employee nor provide the employer with the capability to communicate information about Benefits and Policies/procedures. Current systems do not provide benefit and policy/procedure information in an organized format and that is consistently presented in an easy to access, easy to use format, whether by type of Benefit, Policy; or by a listing of types of events that occur in their life. Current systems are not automated to provide materials (forms, documents, etc.), including any unique or specific information an employer desires to communicate to their employees.

Present methods do not provide the employer the opportunity to communicate all the programs available to employees, which will increase their satisfaction, understanding and perceived value of the programs. The present methods don't provide the ability to give employees one place to obtain Benefit and Policy information. The employer doesn't have a method to easily update and keep information current for the workforce and avoid the cost of printing and distributing materials. Present methods do not provide a place to obtain information 24 hours a day and 7 days a week when needed by an employee, that is at their fingertips, at work or at home. A system is needed that eliminates keeping track of different booklets, phone numbers or multiple web site addresses. Present method do not let employees access forms or other documents 24/7 in an easy to use online manner.

### SUMMARY OF INVENTION

The invention which is referred to as MyHROnline is to provide Employers with an easy, online way to publish Policies/Procedures and Benefit information available to their employees or others to whom they wish to offer access, such as job seekers (together, those will be referred to as “Employees”) via an online brochure. The present invention does not limit the Employer to the pre-programmed information. There is built in functionality known as the MyHROnline wizard, which allows the Employer to edit the pre-programmed information and/or create their own information about any benefit or policy and place the information on an interactive web site accessible by the employees. The present invention lets employers load forms and documents to the site. The present invention allows the site to be as expansive or limited as desired. TheMyHROnline invention allows the employer to provide the desired information to employees, then simply click an icon triggered function identified as “go live” to make the information available to the workforce. The site can be fully hosted by a single server site or hosted on several server sites and can be made available to the workforce 24 hours a day and 7 days a week.

The invention allows the employer to update, change or add to their customized site at any time in a very cost effective manner. In fact, while an employer is setting up their site, the employer can be prompted to enter follow up dates on specific information. If an employer enters a follow up date, the application will send the employer an e-mail on the date specified, linking the employer to the information for follow-up.

MyHROnline organizes the information for easy access. The workforce can make selections by type of benefit or policy or through the FastPath LifeEvent feature may choose to view information organized by life events or view summary information for all benefits and policies/procedures. Employees may also access the document center for form and documents. The forms and documents may also be located in the text of material published to the site for easy employee access. The present invention provides a consistent “look and feel” to the site to allow employees quick navigation. The employees can arrive at an answer to their question in no more than 3 clicks. Because the present invention is designed such that no individualized employee data is stored on the site, one user ID can be communicated to the entire workforce. MyHROnline cuts out the complexity of getting to the information.

This present MyHROnline invention solves the Employer's problems of (1) integrating into a single resource all Benefit and Policy information for Employee viewing without hiring an IT department or consultant to create and maintain it; and (2) receiving expert education and advice on Benefits, Policy/procedure communication.

This is accomplished by the Employer or its consultant completing an easy to use, online, wizard that allows the Employer to present Benefit and Policy information to Employees via a website. The system's flexibility allows the Employer to delegate completion of the wizard to one or more consultants.

The wizard helps to educate Employers with respect to (1) the information they should display about their Benefits; (2) Benefits they may not currently offer; and (3) the employment Policies and Procedures the Employer may adopt and be displayed.

The system allows the Employer to create Policies and Procedures and to create a single on-line resource for Employees to access information about the Employer's Benefits and Policies/procedures. The MyHROnline invention can be designed for simplicity such that it doesn't store Employee-specific data. For example, the system can be designed such that it doesn't store 401(k) balances or medical plan claim data. Instead, the Employer enters addresses of websites that display such data and those addresses can be displayed as links in the portion of MyHROnline that is maintained for that Employer's Employees.

Employers may create this website for Employee view without having to deal with IT support or hosting issues because a MyHROnline server can host and maintain the site.

The MyHROnline wizard for Employers is a “stateless” operating environment. The “stateless” nature of the system means that the Employer (or consultant) need not complete the wizard in a specific order, which facilitates the ability of Employers to complete the system over a series of separate web sessions, to delegate specific parts of the system to others and to easily update parts of the system.

The system is designed such that it can be marketed primarily through Vendors to their customers or members. The MyHROnline site can be accessed by way of a site of the Vendor, which can include consultants, accountants, law firms, mutual funds, banks, trust companies, insurance companies, brokers, TPAs, chambers of commerce, trade associations, et al. The system is operable to assign a separate sub-domain for each Vendor that reflects the Vendor's identity (e.g., www.AAACompany.MyHROnline.Vendors.com).

The system is designed such that each Vendor can specify the fee (or no fee) to be charged to its Employers and the system is operable to store that pricing schedule and display it to that Vendor's Employers. Depending on the pricing selected by the Vendor, the host or owner of the MyHROnline system can either pay a commission to the Vendor or bill the Vendor for its Employers' use of the system.

The system is operable to identify the Vendor to associate with an Employer that accesses the website by the URL used by the Employer. A unique URL is assigned for each Vendor to communicate to its customers/members (Employers) and/or to place as a link on the Vendor's website. The system can also display and market Vendor-specific products to that Vendor's customers/members (Employers).

One reason that the system is easy to use is that the system's expert will enter into the system all of the Benefits, Policies, Questions and Answers that it anticipates most Employers may want to display for Employee view. The Employer only needs to click on those it wishes to display and complete any blanks.

However, the system is also powerful and flexible because the Employer may enter its own Benefits, Policies, Questions and Answers for display to its Employees. For purposes of this document “selected” generally refers to an Administrator-defined item that the Employer has selected to display for Employee view, and “entered” or “employer defined” generally refers to an item the Employer has typed into the system for display to Employees.

Pre-programmed, click-through wizard minimizes employer input. The system's expert is operable to pre-define typical benefits, policies questions and answers for selection by the employer. That enables the employer to click on pre-programmed choices it wants to display that are descriptive of the employer's benefits and policies. The system is operable to ask the employer to provide limited information such as website links for employee-specific data.

The system allows the employer to define its own benefits, policies, questions and answers. The employer is not limited to those items that have been pre-programmed by the system's expert. The wizard allows the employer to enter its own information. This allows the employer to use the system as a comprehensive employee communication tool. The dynamic flexibility of the system permits the employer to use it for any employee communication. This may include key business bulletins or strategy messages, training resources, etc. The site may be as expansive or as limited as the employer desires.

No Employer IT expertise or support is needed. The employer needs no technical expertise, advice or support. The site is operable to go live automatically when the employer clicks “go live.” Because the site relies on links to other sites for employee-specific data, no data links need to be maintained. The site can be maintained by the owner or provider of the MyHROnline system.

Pre-programmed Life Event organization displays may be created. The employer may elect whether or not to organize the display of questions/answers to employees by benefit/policy only or also by life event. The system is operable to automatically define the life events and links the system's pre-defined questions to appropriate life event(s) without the need for employer input.

The present invention is designed such that the wizard is “stateless,” the wizard may be completed in any order and in any number of web sessions. The employer may update or change any part of the system at anytime in a very efficient manner such that the provider could allow such an update for no additional charge. The “stateless” nature of the wizard allows any part of the site to be changed or updated, without re-doing the entire wizard.

As the employer is prompted and selects or enters each answer, it may designate a date on which the system will send an e-mail that prompts the employer to review that answer. The e-mail will include a link to the web page that allows the employer to edit the specific answer.

The system is designed such that employers may choose to give employees access to that employer's employee view MyHROnline through links on the vendor's and/or employer's websites. Employees may also access this by logging on to the MyHROnline site. The employer may elect whether or not to password-protect the employee view of the site.

Multiple sites for different employee groups are allowed. Employers may establish multiple MyHROnline sites in order to communicate different information to different groups of employees. For example, separate sites may be set up for executives vs. rank and file or union vs. non-union.

The system is operable such that the employer can select or add any number of benefits, policies, plans, questions and answers. The employee navigation in MyHROnline provides a consistent look and feel to employees for quick navigation. In the employee view, employees may navigate by choosing benefits, policies or life events. MyHROnline is fully automated, therefore the price can be very modest in comparison to the value added. The product price point is designed to easily meet HR budget levels given the value of the information created.

The vendor may choose the price (if any) to be paid by the employer. Depending on the price, the vendor may receive commissions from MyHROnline or pay MyHROnline for its employers' use of the system.

The system is flexible enough such that an employer may hire a consultant (who may be a vendor) to complete the system for the employer. The system can also provide a recommendation or market the services of a preferred consultant selected by the owner or provider of MyHROnline to employers whose vendor has consented. The employer's reliance on the vendor for access to MyHROnline is value-added by the vendor to the employer. The vendor's name can be displayed at the top of the web pages for its employers.

The vendor's products can be displayed as pre-programmed benefits the employer may communicate to employees. If the employer opts to use a vendor product in which it has an interest, the employer may cause the system to send an e-mail to the vendor from the employer that requests information on that product. The system can also display the vendor's web link and other contact data for information specific to that product.

The MyHROnline system may make benchmarking data related to a vendor's employers available to the vendor. If the vendor permits it, the employer may choose to ask the vendor to post a link on the vendor's website to the employee view of the employer's portion of MyHROnline. This will drive employee traffic to the vendor's website.

One embodiment of the present invention comprises the functions of providing on an employer website from a host server.

These and other advantageous features of the present invention will be in part apparent and in part pointed out herein below.

### BRIEF DESCRIPTION OF DRAWINGS

For a better understanding of the present invention, reference may be made to the accompanying drawings in which:

FIG. 1 is a diagram illustrating the MyHROnline system in a Wide Are Network (WAN) environment;

FIG. 2 is a functional flow diagram of the MyHROnline system;

FIG. 3 is a diagram illustrating the Email function of the MyHROnline system;

FIG. 5a is illustrative of a screen shot and the functional elements of the screen for Employer set up and edits;

FIG. 5b is illustrative of a screen shot and the functional elements of the screen for adding benefits;

FIG. 5c is illustrative of a screen shot and the functional elements of the screen for selecting benefits from a list of common benefits;

FIG. 5d is illustrative of a screen shot and the functional elements of the screen for displaying the benefits list;

FIG. 5e is illustrative of a screen shot and the functional elements of the screen for creating plan names;

FIG. 5f is illustrative of a screen shot and the functional elements of the screen for viewing and working on plans;

FIG. 5g is illustrative of a screen shot and the functional elements of the screen for selecting common questions;

FIG. 5h is illustrative of a screen shot and the functional elements of the screen for Fast Path Life Events;

FIG. 5i is illustrative of a screen shot and the functional elements of the screen for working on and viewing selected questions;

FIG. 5j is illustrative of a screen shot and the functional elements of the screen for selecting common answers; and

FIG. 5k is illustrative of a screen shot and the functional elements of the screen for viewing benefits information selected.

### DETAILED DESCRIPTION

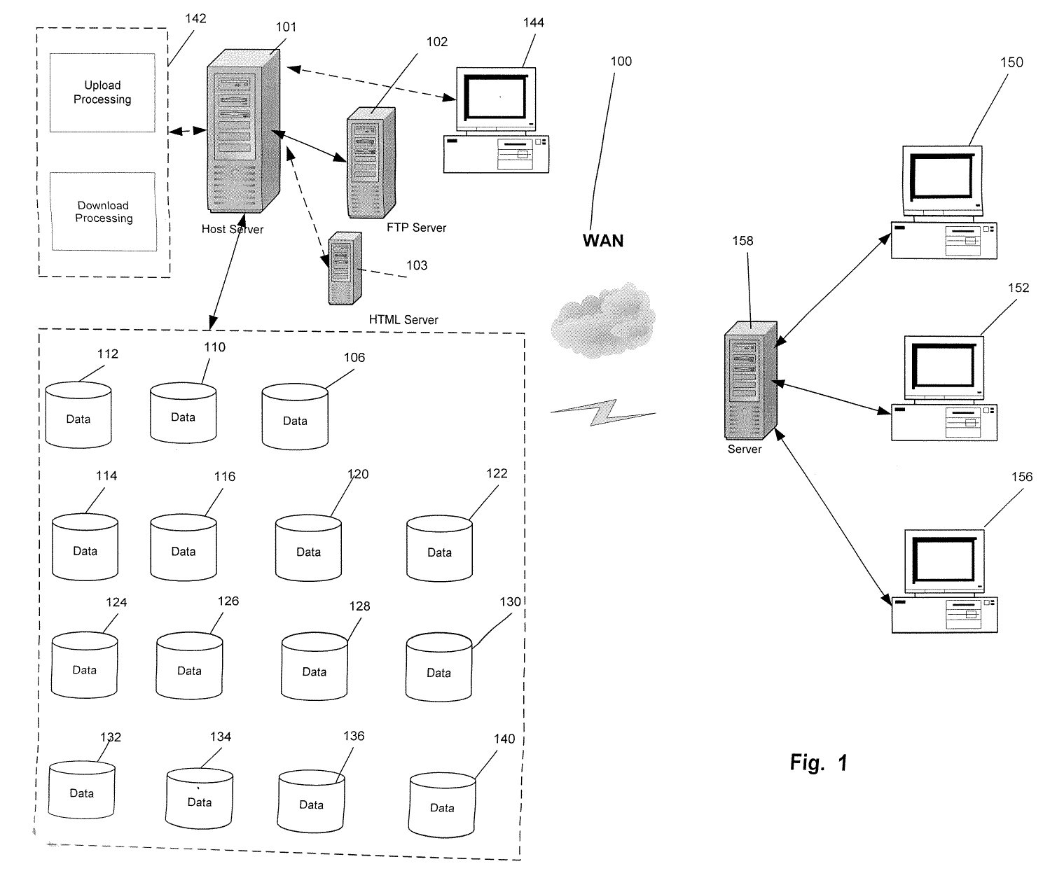

According to the embodiment(s) of the present invention, various views are illustrated in FIG. 1-5 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising an interactive web site for creating a customized web site for communication of benefit and policy information to an employee teaches a novel apparatus and method for communicating benefit and policy information to an employee.

The method comprises the following steps:

Providing a MyHROnline site: From the site home page, an employer creates their own record in the system by clicking purchase and then entering contact information and number of employees, establishing passwords, etc. Based on the alliance partners preference, an invoice with employer pricing may be created online for the employer to remit payment. Alternatively, an alliance partner may also choose to receive an email with price information once the employer establishes a record.

Providing a Delegation option: Where at any point in the system, the Employer may elect to delegate completion of all or part of the wizard to a consultant via e-mail sent by the system to the consultant from the Employer. The e-mail will include a link to the appropriate web pages and instructions. Alternatively, a consultant may log in to the system on behalf of an Employer.

Providing a Benefit/Policy Selection: Where an employer selects the benefits and/or policy information to display to its employees from an expert developed listing or the employer may enter its own unique benefits and policies (e.g., Borders Bookstore Employee Discount Program).

Providing a Specific Benefit/Policy names: Where the employer for each selected benefit or policy, enters a specific name (e.g., under “Medical” benefit, a specific name may be “Blue Cross Blue Shield HMO for Non-Union Employees;” under “Attendance” policy, a specific name maybe “Attendance Policy for Retail Employees”).

Providing a Question Selection: Where the employer selects questions to display to Employees from a best practices listing of questions specific to that benefit/policy, or the employer may enter its own customized questions.

Providing a Life Event selection (all or none selection of pre-programmed life event displays): Where the employer selects whether to organize the display of questions for employee view by just benefit/policy or also by “life events.” The system expert will pre-define all “life events.” If the employer chooses “life event” functionality, any questions it selects from the expert list will automatically be displayed under appropriate life events. The employer may also assign any questions it creates (or selects) to any life events.

Providing an Answer Selection: Where the employer selects answer(s) to display from a best practices listing of answers to the questions the employer selected, or the employer may enter its own customized answers. The answer section asks the employer to provide other website addresses for more detailed or employee specific data. In the employee view of the site, this information will be a link from MyHROnline. This feature allows MyHROnline to become a one-stop location to direct employees to all their available benefit/policy information.

Providing a Request follow-up e-mail: Where as the employer selects or enters each answer, the employer may designate a date on which the system will send an e-mail to the employer as a reminder to update the answer. The e-mail will automatically include a link to the appropriate web pages for the employer to edit the answer.

Providing a Go Live: Where once the employer has selected its benefit/policies, specific names, questions and answers, the employer clicks “go live” and the site will automatically be available in employee view.

Providing an Employee access: Where the employer may instruct its workforce to access the site from a link on its vendor's website, from a link on the employer's website, or the employer may communicate the user i.d. and password (if the employer assigns a password) to its employees.

The details of the invention and various embodiments can be better understood by referring to the figures of the drawing. Referring to FIG. 1 a wide-area network (WAN) 100 is shown depicting the MyHROnline system. The various users of the MyHROnline system can access the MyHROnline application via the Internet. The MyHROnline application is hosted on a host server 101. The host server 101 provides a FTP server interface 102, which provides file transfer protocol services to the various users. The host server also includes a hypertext markup language (HTML) server, which provides hypertext transport protocol (HTTP) World Wide Web server functions to the various connected users. The host server 101 stores and maintains a plurality of data files including a program data library 106 comprising a collection of data files. The various data files can include a follow-up e-mail data file 110 for sending reminders according to a selected schedule. The program data files can also include an employer payments due data file 112 which stores the employer payment data. Other data files include policy, benefit, plans, and life event data files 114, 116, and 120, respectively, which are utilized by the employer to customize the website. Various other data files including an employer, vendor, vendor benefits, and consultant data files 122, 124, 126, and 128, respectively, which store the various user information. There can also be a data file for various employee groupings 130. There can also be an employer questions data file 132 for storing employer-defined questions. There can also be a go live data file 134 for storing the individual customized website information.

The host server 101 can also store Web page data 136 which is presented to the various users. The host server 101 additionally stores and maintains a user data and usage log data base 140 which stores uploaded usage data for tracking user usage. The host server also has an upload and download processing function 142 for upload and downloading processing and compilation. The administrator of the MyHROnline system utilizes a computer 144 for interfacing with the host computer. This interface can be via a local area network as shown or via a wide area network such as the World Wide Web Internet protocol.

FIG. 1 also shows an employer and employee computer 150 and 152, respectively, which is utilized interface to the host server via the Internet. Also shown is a consulting computer 156 which is utilized when the employer delegates responsibility to a consultant. A vendor server 158 is also shown which is utilized when an employer and/or employee accesses the host server through a vendor server.

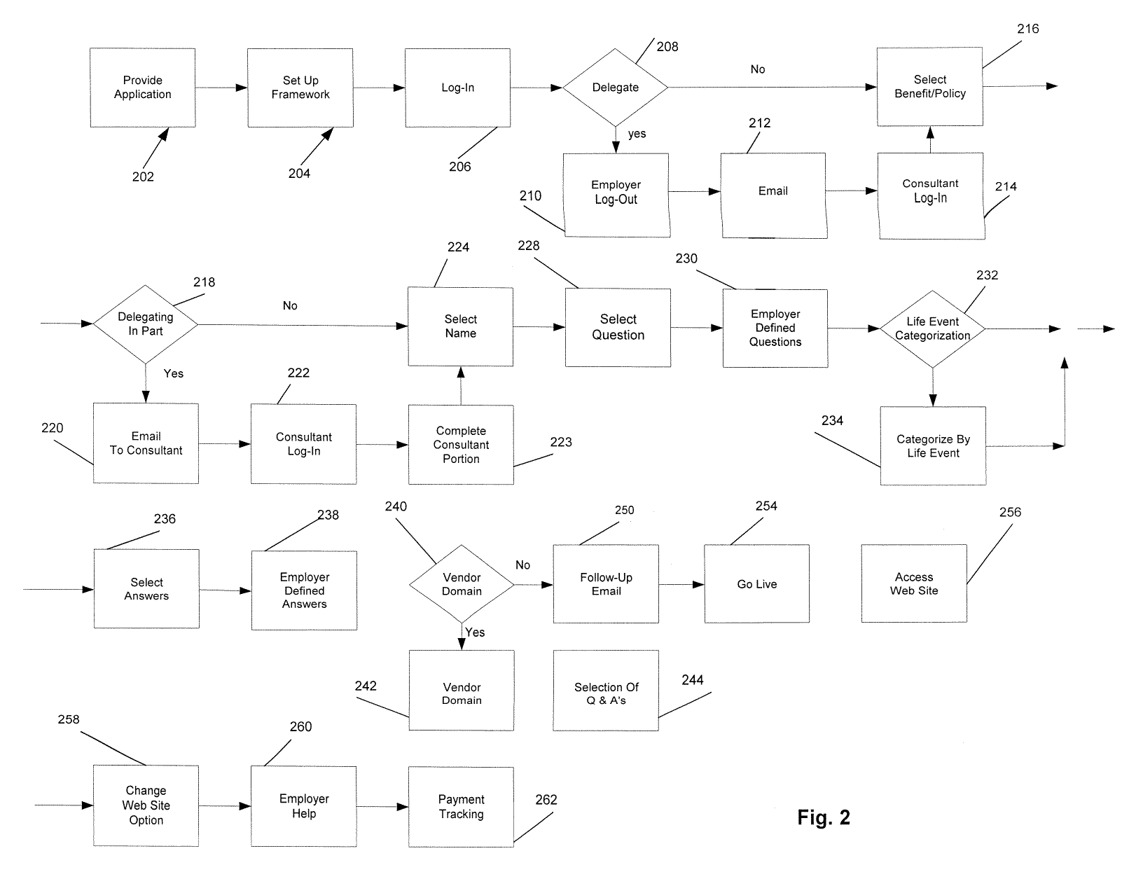

Referring to FIG. 2, a functional flow diagram of the MyHROnline system is shown. The first step in the functional flow is the provide application on host server functional step 202. The next functional step is the administrator set-up framework step 204 which entails the administrator of the MyHROnline system developing a set of expert questions and answers to be later selected by the employer. The next functional step is the employer log-in step 206 which entails the employer logging on to the MyHROnline server. The next functional block is a decision functional block which is the delegate decision step 208. At the functional step the employer decides whether to delegate the responsibility of creating a customized website to a consultant. If the employer opts to delegate their responsibility, then the employer would log out 210 and an e-mail 212 would be sent to the consultant and the consultant would perform a log-in 214. The next functional step is the selection of benefit and policy functional step 216. At this point, the various benefits and policy categories are selected which are to be displayed on the employer's customized website. The next functional block is a decision block for delegating in part 218 functional block. This functional block entails deciding whether to delegate a portion of the responsibility of creating a website to a consultant. If delegation is decided, an e-mail 220 is sent to the consultant and the consultant logs on 222 and completes the portion of the website that was delegated. The next functional block is the select specific name functional block 224 where the specific benefit and policy names are selected for the various benefit and policy categories. The next functional block is the select question functional block 228 which entails selecting the pre-defined questions for the benefit and policy categories. Functional block 230 represents the employer-defined questions which is the step that allows the employer to define its own customized questions. The next functional block is a decision functional block which is the life decision function 232. This decision block entails deciding whether to categorize the selected benefit and policy questions by life events. If the decision is yes, the benefit and policy question selected will also be categorized by life events as reflected by functional block 234. The next functional block is the select answers functional block 236. This functional block entails the selection of expert pre-defined answers for the selected questions. The next functional block is the employer-defined answer functional block 238 which allows the employer to define its own customized answers. The next functional block is a decision block which is the vendor domain decision block 240. This decision block determines whether or not the MyHROnline system is being accessed through a vendor. If the MyHROnline system is being accessed through a vendor, then the MyHROnline system will display unique vendor benefits and allow for selection of question and answers relating to those vendor benefits as depicted by functional blocks 242 and 244. The next functional block 250 is the follow-up e-mail functional block which sends follow-up e-mails to the employer notifying the employer of a scheduled update of the customized site. The next functional block is the go live functional block 254 which launches the customized website and allows employee access. The next functional block 256 entails the employee accessing the customized website that has been launched. Functional block 258 reflects the ability of the employer to change the customized website already created. Functional block 260 reflects the employer help functional block and functional block 262 reflects the employer payment tracking functional block.

Employer Administration

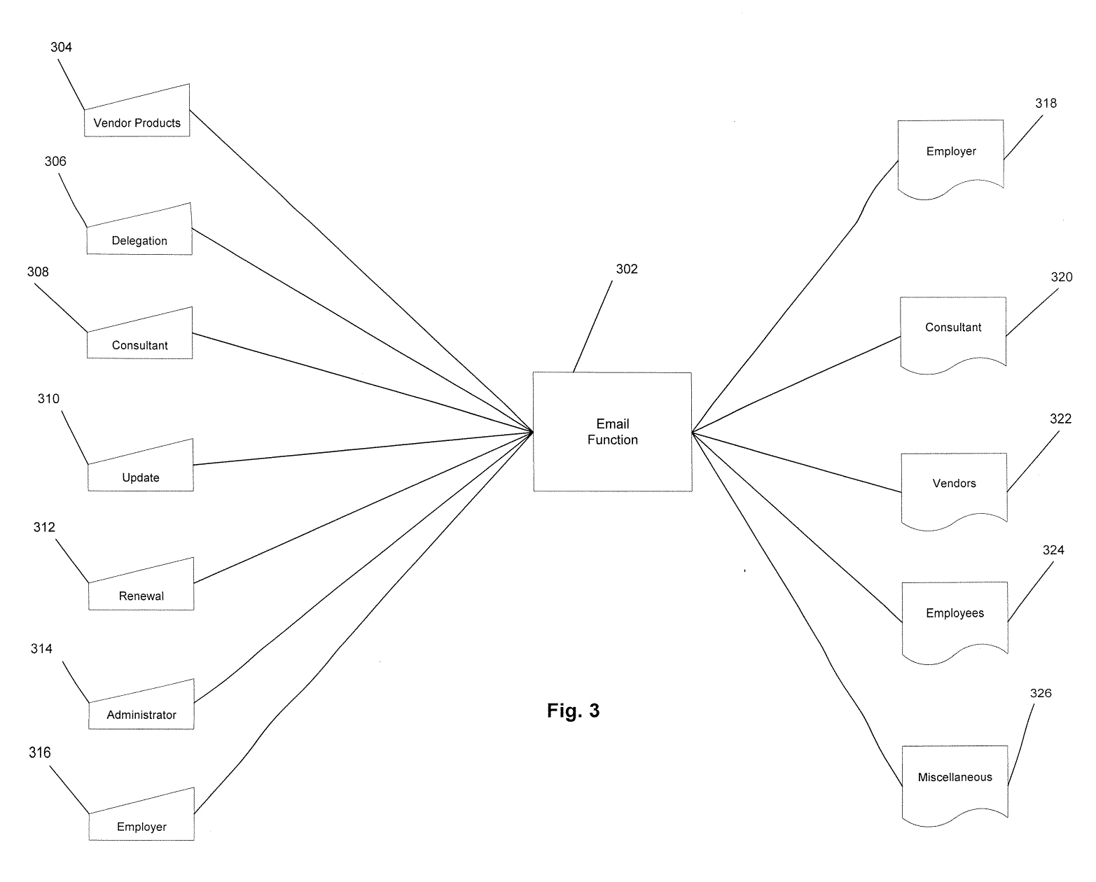

Referring to FIG. 3, the e-mail function of the MyHROnline system is depicted. The e-mail function 302 is triggered by various functional events which cause an e-mail to be transmitted to an addressee. One functional trigger for sending an e-mail is an employer request concerning vendor products as shown by functional block 304 which causes an informational e-mail to be transmitted to the vendor requesting information about the vendor's products/services. A delegation functional trigger 306 triggers an e-mail transmission when a delegation is made. If the employer opts to delegate all or a portion of the responsibility for creating the customized employer website, then an e-mail is transmitted to a consultant who will perform the task. There is also a consultant functional trigger 308 which occurs when an employer requests a consultant to be provided. This e-mail functional trigger causes an e-mail to be sent from the employer to the consultant. An employer update functional trigger 310 is shown which occurs when an employer requests a reminder for a scheduled update. An e-mail will be transmitted to the employer at the scheduled time reminding the employer to update the information on the customized website. A renewal functional trigger 312 is shown which occurs when a renewal of an employer account is required. An e-mail is transmitted to the employer reminding the employer that a renewal payment is due. The administrator functional trigger 314 and the employer functional FIG. 316 are also shown which are functional triggers that can be initiated by the administrator or the employer for transmitting various e-mail messages to employees, vendors and consultants. Functional blocks 318, 320, 322, 324, and 326 are representative of the possible recipients of e-mail messages and is also representative of their ability to respond via e-mail.

The system is operable such that an Employer can log onto the MyHROnline or MyHROnlineVendors website and enter information with respect to the topics described below. The remaining paragraphs under this section describe other aspects of Employer administration.

Delegation: The system is operable to facilitate two forms of delegation. One is to delegate to a consultant the task of completing the entire system on behalf of, and for review by, the Employer. The system is operable to offer a consultant to each Employer that will be specific to the Vendor for that Employer. The Administrator can designate those consultants in the Vendor databases.

The other form of delegation is that at any step in the Employer's navigation of the wizard, the Employer may delegate completion of part of the wizard to someone else via e-mail sent by the website. The e-mail can embed the security for the delegate to go to the page on which the Employer was located when it elected to delegate. The Employer may enter the e-mail address of the party to whom the matter is to be delegated.

MyHROnline is operable to provide hard coded text that will be the text of the e-mail to the delegee, which text may vary programmatically based on the web page from which the Employer elected to delegate. The delegee can have all Employer administration rights.

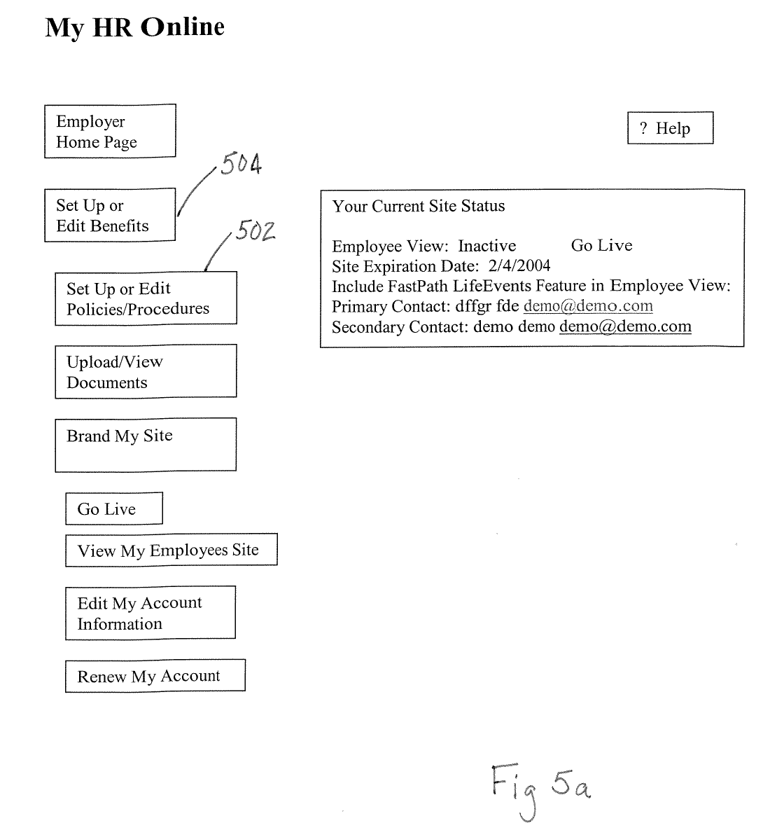

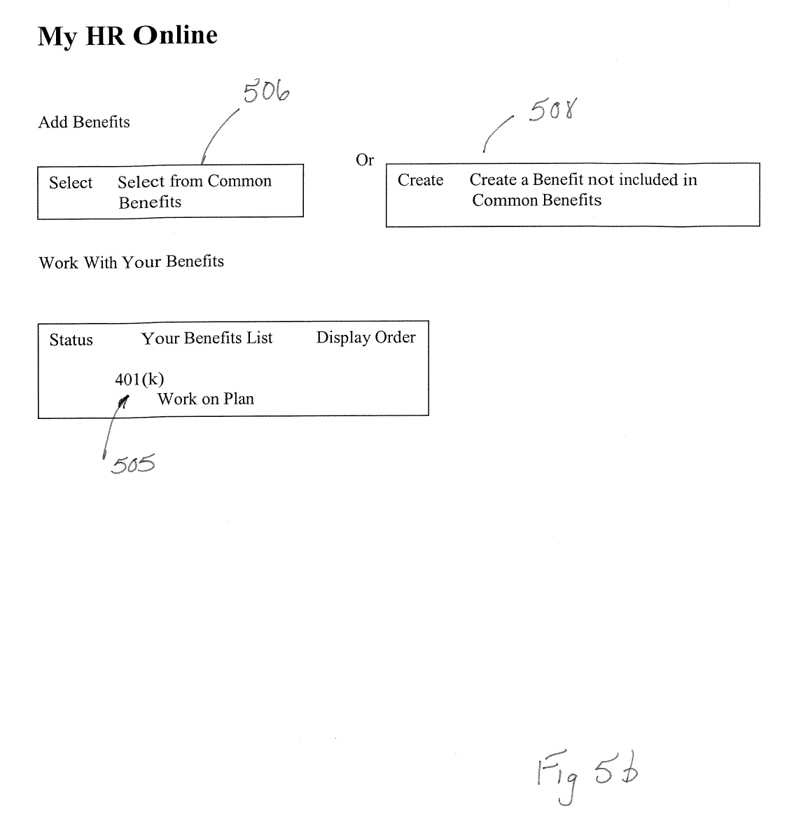

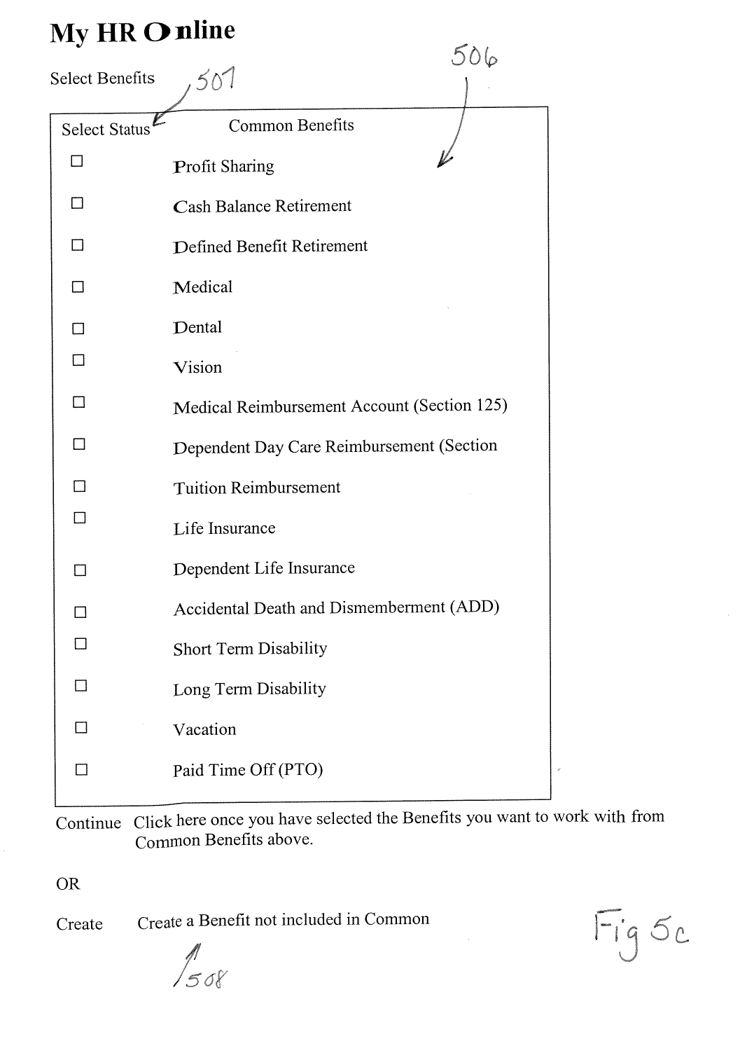

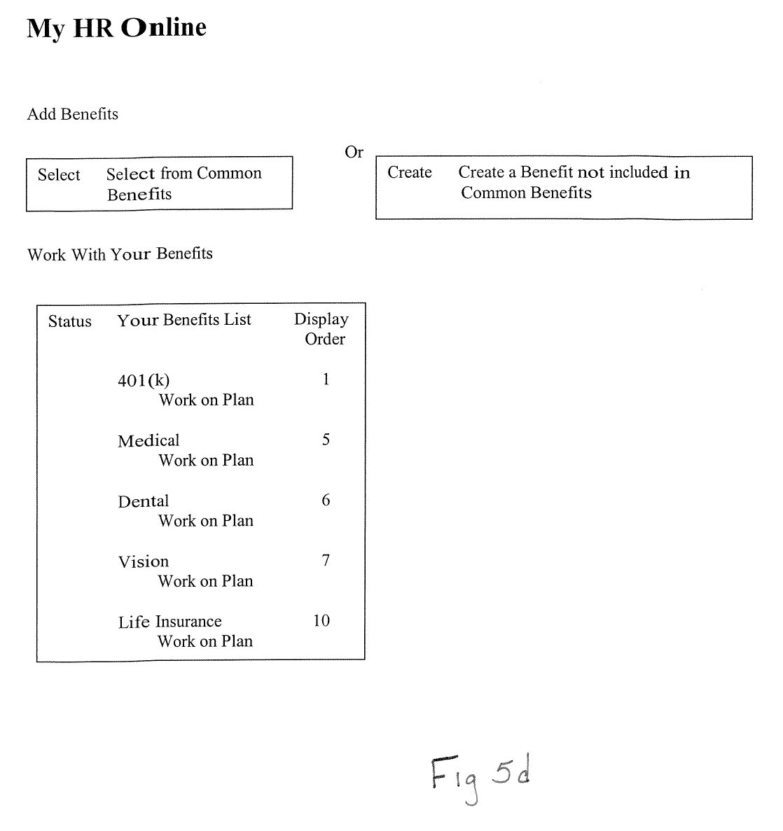

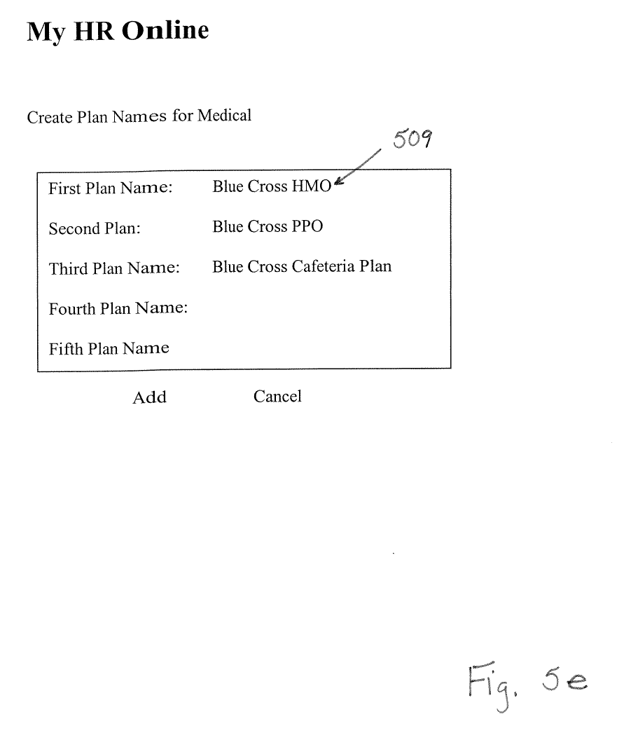

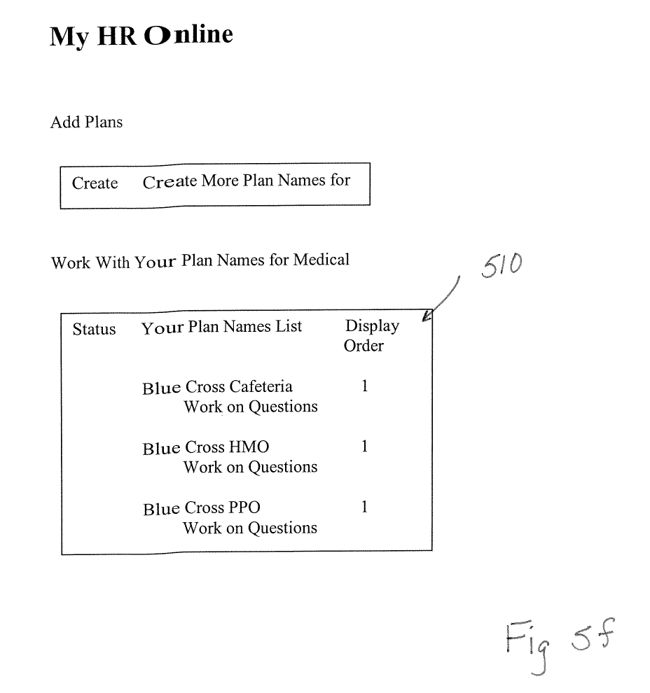

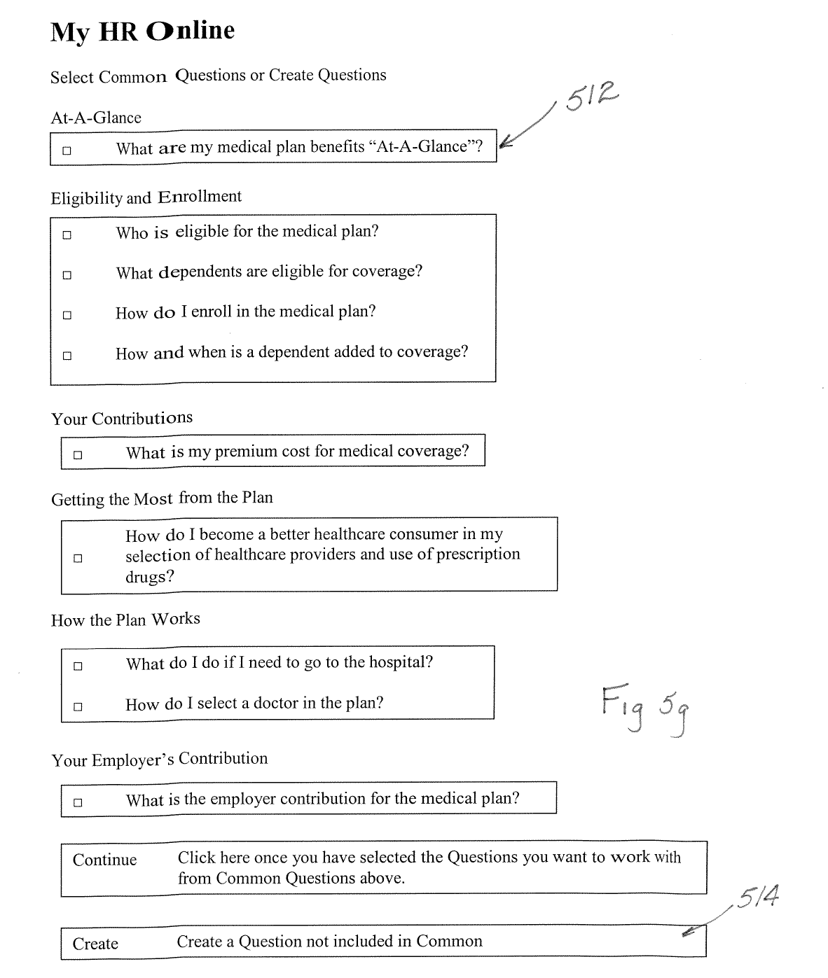

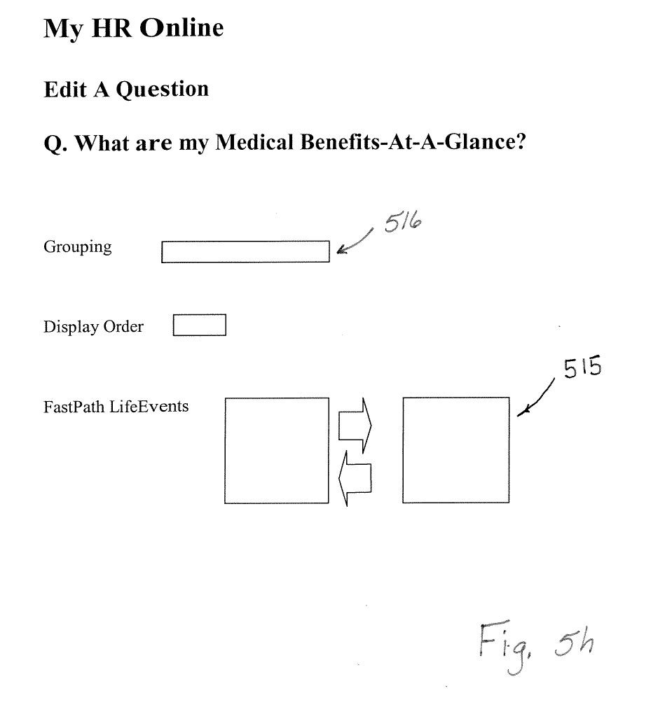

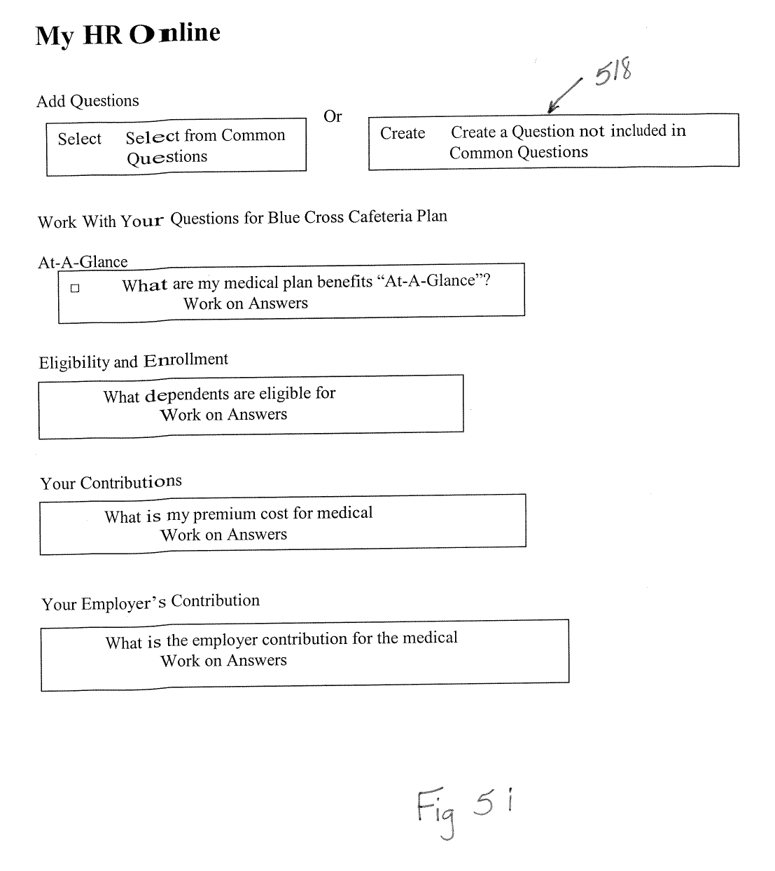

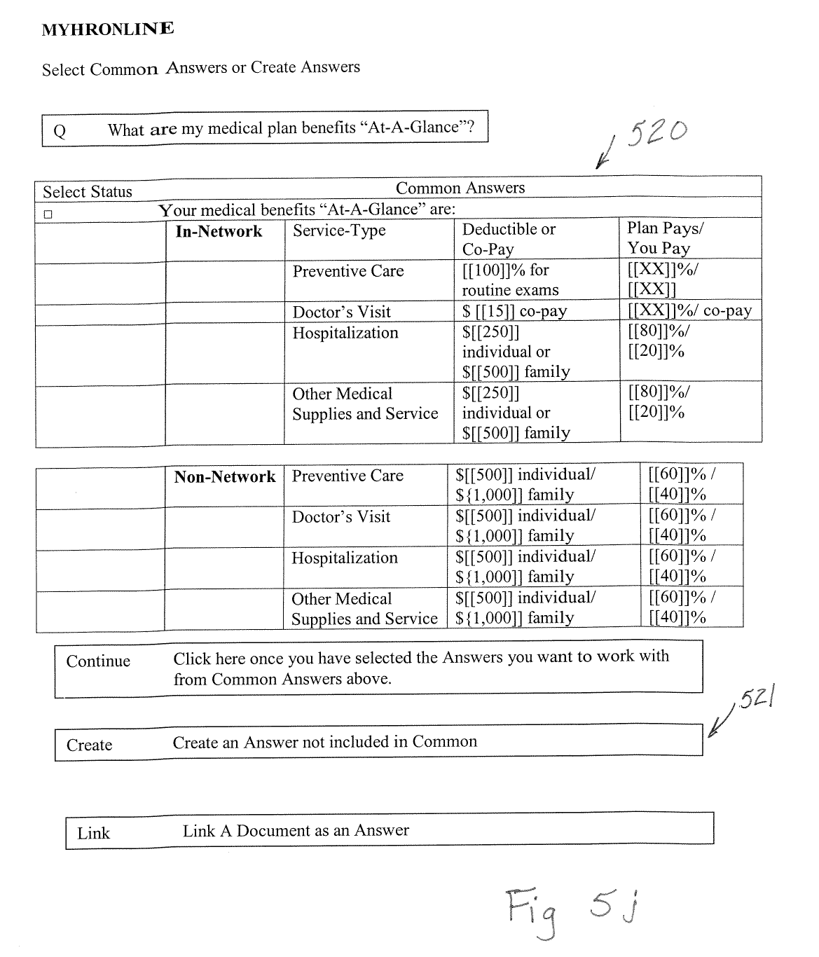

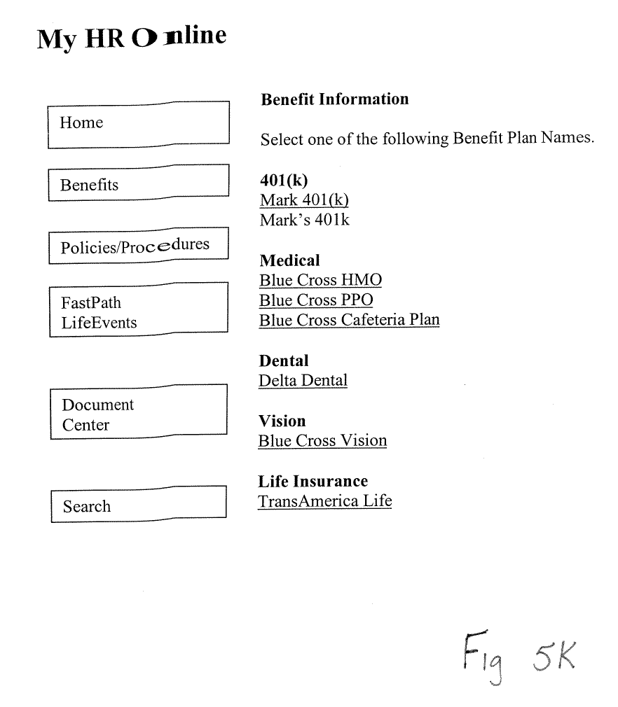

Policies: The “Policies” part of the system is operable to allow Employers to publish policies and procedures and offer them for view by Employees on this website. One can initiate this process by selecting the Set Up or Edit Policy/Procedure Option 502 as seen on the sample screen shot shown in FIG. 5a. The procedure for the Administrator and Employer completing this portion of the site is the same as for the Benefits portion (including Life Event, More Info, Important Info, Delegation and Follow Up functionality), except that “Benefits” will be labeled “Policies,” and “Plans” will be labeled “Applicable Employee Group.” This functionality permits Employers to designate different Policies on the same topic for different groups of Employees. For example, the smoking Policy in one facility may be different from the smoking Policy in another facility.

Benefits: The Employer chooses the types of Benefits it wants to communicate to its Employees through this system (e.g., retirement, health, life insurance, vacation). One can initiate this process by selecting the Set Up or Edit Benefits Option 504 as seen on the sample screen shot shown in FIG. 5a. The Administrator function of the MyHROnline method and system can define “core” Benefits 506 as seen in FIG. 5c that will be displayed for the Employer to choose to communicate (“Employer-selected Benefits”), and the Employer is allowed to enter other Benefits that it enters into the system (“Employer-entered Benefits” or “Employer-defined Benefits”) as reflected to create a Benefit Selection 508. The Benefits field size for the Employers to enter additional Benefits will be adequate for the business case. One can select or de-select items on the common benefits list by selecting or deselecting the select status boxes 507 adjacent the benefits. The “Your benefits list” 505 of FIG. 5b shows the Employer created benefits.

The Administrator function may also define Benefits that are specific to the Vendor identified by the URL on which the Employer gains access, and those Vendor-specific Benefits can be displayed on that Vendor's sub-domain that the Vendor's customers/members (Employers) access. Employers may also select any Vendor-specific Benefits displayed to them. All Vendor sub-domains can display all core benefits, unless all core benefits are disabled by the Administrator for a specific Vendor. In order to facilitate the Administrator's ability to enter the text of certain “core” items in Vendor-specific items, the system can allow the Administrator to highlight, copy and paste text from core to vendor-specific items.

Plan: For each Benefit selected as shown in FIG. 5d, the Employer enters the name of each plan it offers as demonstrated by FIG. 5e where the fields 509 prompt the user to enter plan names. (e.g., Blue Cross Blue Shield HMO, Blue Cross Blue Shield PPO, Vacation Benefits for Union Employees and Vacation Benefits for Non-Union Employees.) The Plan field size can be designed to be adequate for the business case.

Questions: For each Plan selected 510, as shown in FIG. 5f the Employer can choose Questions that will be displayed for Employee view, for example, see FIG. 5g for a sample screen shot. The Employer may choose from an Administrator-defined set of Questions 512. If the Administrator wants to define Questions that are specific to the Vendor identified by the URL on which Employer gained access, that may be done by the Administrator attaching those Administrator-defined Questions to a Vendor-specific Benefit.

The Employer may also enter its own custom Questions for each Plan. The Question field size can be designed to be adequate for the business case. The employer (or consultant) setting up the site will see the vendor specific questions if they select the vendor specific benefit (policy). Vendor specific benefits would appear on the common policy list (refer to FIG. 5c, 506) at that vendor's sub-domain. The Employer may designate one or more Life Events 515 to which an Employer-defined Question should be associated as shown in FIG. 5h, 515. The system may specify that if the Employer has shut off Life Events, then the Employer will not have Life Event designation choices on the Employer-defined Question Screen.

The MyHROnline system is operable such that the Administrator can designate “groupings” 516 for Questions. One embodiment of the system is designed such that each Question can be assigned to only one Administrator-designated group. With this embodiment the Employer can not edit the list of groups that a question may be associated with, but may choose from a group list for each question. The Employer can designate each Employer-entered Question to one Administrator-designated group (an Employer-entered Question may not be assigned to more than one Administrator-defined group). Any Employer-designated Questions that have not been assigned to a group can be assigned to “Other” if there are groups for the Benefit/Policy or to no group if there are no groups for that Benefit/Policy.

This “grouping” functionality is designed to facilitate Employee and Employer navigation of the site. For example, under the 401(k) plan, all Questions related to eligibility can be listed under the “Eligibility” grouping under the 401(k) Plan. Groupings can be presented alphabetically under each sub-category (Plan or Applicable Employee Group). Only the groups assigned to Questions under a given Benefit/Policy will be displayed. For example, the grouping, “Pre-authorization,” will not appear under the “401(k)” Benefit if there is no 401(k) Question assigned to that group.

The system can be designed such that if an Employer chooses to have Questions sorted by Life Events, any given Question can be accessed in Employee view either through Plan or, if the Question has been associated with one or more Life Events, through those Life Events. If the Administrator designates more than one Life Event for a particular Question, then that Question may be accessed in Employee view under all such Life Events. The Employer will only be required to answer the Question once even though it will appear under both Plans and Life Events in the Employee view.

On the “Add Question,” screen displayed to Employers, the Benefit/Policy, Plan/Applicable Employee Group, all Administrator-defined Questions for that Benefit/Policy sorted by grouping, and a button or option 518 to enter an Employer-defined Question will be displayed. If an Employer clicks on an Administrator-defined Question or on the button to add an Employer-defined Question, then a separate page would be displayed that would allow the Employer to edit the Administrator-defined Question or to enter the Employer-defined Question, as the case may be. If the Employer is defining a Question, then that page will display all relevant controls (Life Event association, Grouping, Important Info.), see FIG. 5h. Once the Employer saves that page, the next page displayed will be the “Add Question” page or their shoebox, depending on what makes sense.

Answers: The system is operable such that for each Question selected or entered, the Employer can choose Answer(s) to display to Employees as seen for example in FIG. 5j. In the case of Administrator-defined questions, the Employer can select one or more Answers from among Administrator-defined Answers 520 and/or the Employer can create its own Answers, see FIG. 5j, 521.

The system is also adapted such that if the Administrator wants to define Answers that are specific to the Vendor identified in the URL on which the Employer gained access, that may be done by attaching them to an Administrator-defined Question under a Vendor-specific Benefit. One embodiment is designed such that the Employer must enter an Employer-defined Answer to each Employer-defined Question. The “Answer” field size will be adequate for the business case.

On the “Add Answer” screen displayed to Employers, the Benefit/Policy, Plan/Applicable Employee Group, Question, all Administrator-defined Answers for that Question, and a blank box for an Employer-defined Answer will be displayed. For one embodiment, Navigation similar to that described above for Questions can be used for Answers in order to be consistent.

Within any Administrator-defined Answer, the Administrator is allowed to designate that the system must require the Employer to enter certain described information in order for selection of that Answer to be accepted by the system. For example, a phone number, a group ID, a hyper-linked website, etc. For Answers in which the Employer must embed specific data in an Answer (such as a phone number or website) this area can be bracketed [[ ]]. If the Answer involves a website address, the Employer can be prompted by http://[[link]]. The system has been designed such that the Employer is not able to leave an Answer page if they chose an Answer that still has brackets around an embedded Answer. If an Employer enters a website address, this will appear as a hyper-link in the Employee view.

Life Events: With regard to Life Events, the system is adapted such that the Employer can designate whether to display Life Events for Employee view. A button or option can appear on the Employer Account Edit page that will allow the Employer to “Disable Life Events” (“on” is default). The Administrator can designate any Administrator-defined Questions under Benefits and/or Policies as being associated with one or more Life Events. One embodiment of invention functions where The Employer can edit the Life Events chosen by the Administrator (e.g., death), can edit the Administrator's assignment of Administrator-defined Questions to Life Events and can omit selected Life Events. In other words, Life Event functionality is at the Employer's election. However, the Employer is not required to complete any or all Q/A that are tied to Life Events, notwithstanding the Employer's failure to disable Life Event functionality. Furthermore, if an Administrator-defined Life Event has no Employer-selected or Question associated with it, then that Life Event will not be displayed for Employee view. Furthermore, the Employer may assign Employer-entered Questions to Administrator-defined Life Events. A Vendor sub-domain will have Life Events even if “core” benefits are disabled for that Vendor.

Follow Up: The system is designed such that it can give the Employer the ability to designate a follow up date to change or review any selected or entered Answer. If the Employer designates a follow up date for an Answer, an e-mail reminder is scheduled to be sent to the Employer to prompt it to update the Answer. The e-mail will include a link with embedded security to the pertinent Answer screen in the Employer-administration functionality for that Employer.

Going Live: The Employer can track its progress in the system through indicators next to each selected or entered Benefit/Policy, Plan/Applicable Employee Group and Question. For example, a negative indicator (a red square), can be displayed until all conditions necessary to make the indicator positive are achieved. For example, a positive indicator (a green light in the shape of a circle), can be displayed when all conditions are satisfied to make it positive. The indicators are based on color and shape due to the possibility of color-blindness.

For every selected or entered Benefit, there is at least one entered Plan; for every entered Plan, there is at least one selected or entered Question; for every selected or entered Question, there is at least one selected or entered Answer. One embodiment of the invention can be such that there will be no indicators next to the generic category, “Benefits” on the home page. However, there will be an indicator next to each selected or entered Benefit.

The functionality can be such that for each selected or entered “Benefit” (e.g., 401(k) or health), the indicator can be positive when all of the above conditions are met. The indicator next to each entered “Plan” can be positive when all of the above conditions related to “Questions” and “Answers” are met. The indicator next to each selected or entered “Question” can be positive when the above condition related to “Answers” is met.

Until all indicators are positive, the system can display a message to the Employer if the Employer clicks on the “Go Live” button. The message can inform the Employer that more information is needed and to click and complete all items that do not have a positive indicator. Once all indicators are positive, the system can go live when the Employer clicks on “Go Live.” However, if nothing has been selected or entered in Benefits, Plans, Questions and Answers, but all indicators are positive for Policies, Applicable Employee Groups, Questions and Answers, or vice versa, then the system can go live when the “Go Live” button is clicked. “Going Live” means that Employees may view the portion of the system's site on which that Employer's information is displayed. That portion of the site can be identified by a code for the Employer that will appear at the end of the site's URL for that Employer.

Upon clicking “Go Live” the website will display and e-mail instructions to the Employer to provide Employees the system-assigned URL for Employee access to the portion of the site on which that Employer's information is displayed. The system can display e-mail instructions to the Employer for installing a link to this site on the Employer's intranet or external website.

Navigation: Navigation for the employer is consistent throughout the site. The employer follows the red square and clicks the “work” on link under the item to be completed until all elements of the site are complete with the completions indicator displayed.

Employer changes to the Employee view: The system will allow Employers to edit, delete or add Benefits/Policies, Plans/Applicable Employee Groups, Questions and Answers at any time. Employers can also enable or disable Life Events or enter new Follow-Up requests at any time. The live site can be edited as the Employer saves changes even if there is a negative indicator by the changed item. The system also equips The Employer to disable the site from Employee view until edits are completed. If the Employee view is disabled. Employees will see a message that their site is not currently available to try again later.

If the Employer makes any additions, a negative indicator can be displayed until the items below it are also handled by the Employer. For example, if a Benefit is added, a negative indicator will appear by that Benefit until the Employer enters at least one plan name for that benefit, and so on.

If the Employer deletes an item, all items below it that are linked to that item will be deleted from Employee view. For example, if “Medical” is deleted from Benefits, the system will delete from Employee view all Plans, Questions and Answers related to the Medical category when the Employer confirms deletion (after a warning is displayed of what will be deleted and the Employer confirms the deletion). The system will not continue to store the data. Therefore, if the Employer re-selects “Medical,” it will have to re-enter all data.

Employer Admin. Security: The system security can consist of a single sign-in. Each Employer can have a username and password (both chosen by the Employer) for entire access to their portion of the site. The Employer can access the site's home page and click on “Employer,” and enter username and password. The Employer can also access by using the URL for its administration page in the system, in which case it will enter its password.

The Employer can (but is not required to) also designate a password that Employees would use to sign on to the system (in conjunction with the Employer's System ID). Employees who access via www.MyHROnline (primary domain) can be prompted to input the Employer username and, if the Employer requires it, password. The system requires that the Employer and any Employee password be different. If no Employee password is entered by the Employer, then the default is that Employees will have total access to the Employee view portion of the Employer's information. The system can be designed such that Employees are required to use an Employer ID unless they use a link communicated to them by their Employer or Vendor. The Employer may also customize a specific URL address for its workforce. For example, http://abcco.myhronline.com. Upon entering the URL address, employees are taken directly to their employee log in page. This page may also be branded with an employer logo.

When setting any password, the Employer can be prompted to enter the desired password twice. A user name and any password may be changed at any time. An Employer's username or password will not be deleted until the Employer successfully saves new ones, even if the web session ends after the Employer has input but not successfully saved the new username and password. Employer username and password are required fields. An Employer or Employee who is attempting to log in can be allowed to enter an incorrect username or password three times, after which the system displays an error message when subsequent login attempts are made, until a new web session starts. If the Employer forgets its password, it may request an e-mail from the system, which contains the password. If an Employee forgets the password, he or she may cause the system to send an e-mail to his or her Employer's e-mail address stored in the database.

“Help” for Employer: A single HTML page static help system that is linked from various elements in the web site (i.e., Benefit/Policy, Plan/Applicable Employee Group, Question, Answer, etc.). The link can take the user to the appropriate section of the help page. The static help system can have an index at the top of the page.

Employer Payment: The employer will either remit payment directly to my HROnline or to the alliance partner, depending on what the alliance partner has determined.

For renewal of an Employer, the system sends an e-mail to the Employer 60 days prior to renewal. That e-mail requests payment of the renewal fee. The Employer's system i.d. can be included in the e-mail. The Employer is instructed to log in and update its number of employees so that an invoice is created for the employers payment remittance. If, at the end of an Administrator-entered grace period following the expiration date, if the Administrator has not indicated to the system that a check has been received, the system would automatically inactivate the Employee-view, but an explanation would be displayed to Employees that gives the Employer's e-mail addresses to contact. The system can re-activate the Employee view if the Employer logs in and makes a payment or the Administrator indicates to the system that a renewal payment was received.

Expiration: The initial expiration date for each Employer is set by the system regardless of payment method. The initial expiration date can be the number of days set by hard code after the date of creation of the record for that Employer. The Administrator can change any Employer's expiration date. There can be a hard coded grace period so that the system would remain live for Employee view after the expiration date, until the end of the grace period. Regardless of when an Employer renews (either before or after the expiration date), the renewal can result in the system setting a new expiration date that can be a hard coded number of days after the most recent preceding expiration date. The Administrator can override an expiration date if the Employer has been turned off for an extended period.

If the grace period ends without renewal, the Employee view can be disabled, ADMIN can run a report of inactive Employers sorted by expiration date, and can permit ADMIN to delete an Employer's record from the database. In the home page for the Employer's administration, that Employer's expiration data can be displayed at all times.

Multiple Sites for Single Employer: An Employer can set up more than one site as long as it enrolls again as a new Employer and establishes a separate user id. (e.g., the Employer might want to set up a separate site for Executives because of perqs or may want separate sites for union and non-union employees) The hard coded explanation of the system to the Employer will explain this functionality. The system can be designed such that it will not allow an Employer to choose a username that has already been chosen in the system.

URLs: The system can assign, display and e-mail to the Employer the URL for the Employer-administration home page. The system can assign, display and e-mail to the Employer another URL for the Employee view.

Terms & Conditions: Fields to display the site's terms and conditions to Employers and Employees are included as part of the employers set-up record. The employer must check a box indicating that they agree with the terms and conditions before the site may be established. In addition, an email is automatically sent to the employer once the record is activated containing the terms and conditions. Each time the employer or employee log in to the site, the log in page contains a link to the terms and conditions.

Administrator Functional Requirements:

Inputting the substance of the site: The MyHROnline system is designed such that the Administrator of the system can set up the core Benefits, Policies, Questions and Answers and their respective relationships, which establishes the framework for a Employers customized web site. Benefits, Policies, Questions and Answers that are not Employer-entered are entered by the Administrator of the entire system.

Vendor-based Marketing Structure: The MyHROnline system is designed to be marketed directly to Employers, but is also flexible enough that it can be marketed to companies known as Vendors. The MyHROnline system can be provided by Vendors to their member Employers at a rate to be charged to the Employer and/or Vendor negotiated with the MyHROnline Provider/Owner. The system can track those rates by Vendor through the Administrator's Vendor setup. There is also a potential payment from MyHROnline to Vendors. The Administrator can utilize the system to run reports that can provide it with information necessary for the Administrator to bill or pay Vendors based upon the agreement with the Vendor reflected in the Vendor setup. This information can be captured in the application, and reports can be made available to determine the Vendor's Employers who have paid the initial enrollment or renewal fee and the amount paid, sorted by date range by Vendor. The system is operable to send an e-mail invoice to Employers that elect to pay by check, and the Administrator is able to run reports to track that billing function.

The application can allow Administrator to vary pricing based on vendor and based on the three tier Employer size. All Vendors can have the same tiers, but the price for each tier are likely to vary by Vendor. The Employers can see pricing information specific to their size after choosing their number of employees.

A portion of the marketing for the site can comprise referrals through benefit Vendors. The system can track the vendor referral information such that a referring Vendor receive credit for the referral. One domain (e.g., MyHROnline.com) can be established for the non-referral, employer direct market. Each vendor can be set up with a subdomain such as <vendor>. MyHROnlineVendors.com. This sub-domain can point to the exact same set of code as MyHROnline.com, except the information displayed to the Employer will be Vendor-specific. The system can use the domain information to give Vendors referral credit. At the time an Employer decides to purchase the system, they will fill out their profile page. If the URL on which the Employer entered the site was a Vendor URL, then a link can be made in the database between Vendor and Employer. Access to MyHROnlineVendors.com can be denied to anyone who does not start the URL with <vendor>. If someone arrives at the MyHROnline URL but a vendor sub-domain is not specified in the URL, then a message can be displayed informing the visitor that he/she may access this site only through a referring vendor's site.

To the extent the Vendor permits it, a button can be made visible at the Administrator's initiative, which allows that Vendor's Employers to “Learn More About This Vendor's Benefit.” This may be available for all or less than all Administrator-entered Benefits for that Vendor. If a Core Benefit has a “MORE INFO” button, then the button can appear for use by anyone on any sub-domain (or MyHROnline) that includes the Core Benefits. If the Employer clicks on that button, contact information for that type of Benefit can be displayed. Clicking on “MORE INFO” generates an e-mail to Vendor, from Employer, cc: Administrator. Whether to display the “MORE INFO” button for any Vendor-specific Benefit(s) will be Vendor-specific. The information to display and the e-mails to generate when “MORE INFO” is clicked will also be Benefit-specific.

ASP Model: The system can be delivered in an Application Service Provider model where the entire application and all functionality can be hosted on a server that is maintained and paid for by the MyHROnline provider. An alternative embodiment is where a Vendor hosts this application on its own site. It is possible to install the application on any Microsoft web server with a SQL Server back end or any substantial equivalent. The Active Server Page code base can be visible to the Vendor and a Visual Basic DLL can secure the core functionality from the Vendor's view.

Demo: For purposes of demonstrating the system to Employers and Vendors, the system is designed such that a tour page can be created that consists of links to “sample” Employee views for a fictional employer that completed the system. This can be used to help sell the Employer on the concept of this system. There can also be text and the number of screens to demonstrate the Employer Administrator functions required to deliver the end product for the purpose of teaching the Employer how to use the system. In addition, HTML text at set-up can also mention the ability for the Employer to use a consultant to set up the entire site. Because the Vendor could be a consultant, the Administrator may enter in each Vendor database the identity of the consultant who is to be displayed on that Vendor's sub-domain. Since the consulting fee can vary depending on the amount of data the Employer wants put on the site, the Employer can be referred to the Vendor or Consultant via e-mail.

Vendor labeling on sub-domain: Because it is important for the MyHROnline service to assist in enhancing the relationship between the Vendor and Employer, the initial HTML pages for the Employer login in the vendor sub-domain will include reference to the referring Vendor. The Administrator can also designate in the Vendor database that the Vendor logo appear in the header block on all pages of the Vendor sub-domain for Employer set-up and/or Employee view.

Link from Vendor site to Employee view: On the Vendor administration screens there can be an indicator for Administrator to designate whether the Vendor has agreed to provide a link from its site for Employee view. If this is yes, then an e-mail can be generated to the vendor when an Employer goes live so that the link can be added for the Employees of the Employer. That e-mail can be sent to the Vendor only if the Employer clicks “send.” The Employer may instead “cancel” that e-mail.

Important Info: The system is operable such that during the Administrator set up for Questions, the Administrator can have the ability to designate an “Important information” button for a particular Question. If this field is greater than 0 for a question, an Administrator scripted message (not hard coded) can appear in a pop-up window if the Employer clicks on “Important Info.”. This text can be used by Administrator to suggest that there are sources (e.g., legal help) for answering the Question. If the “important info” field is left blank during the Administrator Question set up, then no “important info” link is displayed on the Question. Admin is also able to create Comment/Alternative Answer link so that the employer setting up the site may learn about issues to consider in their benefit plans/policies.

Functional Requirements of Employee View:

The Employee view can be designed such that it is a Read Only view of what the Employer has set up in the Employer Admin system.

Employee Access: The Employee may access in three ways: (1) MyHROnline.com (the primary domain), which requests the Employee to enter his or her Employer I.D.: [Employee fills in] and (if Employer specified) password: [Employee fills in]; (2) a different page can be written that takes username and password (if one is specified by the Employer) as parameters for automatic Employee login. That page may be accessed via a URL that embeds username and password. That page with embedded security can be generated in the Employer administration page and can be displayed and e-mailed to the Employer with instructions for installing the link on the Employer's intranet or other site. That URL may also be sent to the Vendor. A 3^{rd} alternative can be a URL that includes an the Employer sub-domain (ex. Abcco.myhronline.com). In that case, the Employee can enter any Employer-required Password. The system displays the alternatives to the Employer so the Employer can choose one or both ways to communicate links to Employees. The system can be designed such that the Employee will have to provide a password, if the Employer sets up a password for Employee access, unless the password is embedded in a URL supplied to the Employee.

Employee Home Page: The Employee Home Page contains the sections with respect to which the Employer has answered questions in the listing. For example, if an Employer only answered Benefits questions, the Policies listing would not appear in the Employee view and vice versa. The Employee Home Page can include a button for Life Events, unless the Employer has disabled that functionality. The following is a list of the potential “top level” buttons on the Employee Home Page see FIG. 5k:

Benefits

Policies

Life Events

Document Center

Employee Navigation: The Employee navigates through these sections by clicking the appropriate link. The drilldown for Benefits or Policies is the same as in Employer Admin: CAT>SUBCAT>Q>A. All questions under a Subcategory can be listed by groupings. For example, “Eligibility” may be a grouping and all questions the Employer answered for that subcategory that the system administrator designated as being a part of the Eligibility group for that category can be listed under that grouping. If the Employer did not answer any questions in a particular grouping then that group listing will not appear in Employee view.

The left navigation buttons stay on the page at all times. After selecting an item from the navigation buttons, the listing of all benefits or policies display. The employee then chooses a benefit plan name or policy name. The listing of questions is then displayed. The employee clicks an indicator to open the answer to the question. The employee is never more than 3 clicks from the answer. The employee may view all material on the page or may close all material on the page to a listing of groupings.

Life Events: If an Employee clicks on “Life Event,” the system can display all Life Events; if he clicks on a particular Life Event, the system can display all “Plans” that have Questions selected or entered by the Employer that have been linked to that Life Event and the system can also display under each of those Plans all “Questions” under each of those Plans that have been linked to that Life Event. Employee may click on any Question. If the Employer selected or entered no Questions/Answers that are linked to a particular Life Event, then that Life Event will not be displayed.

The system can be designed such that there are no question groupings or Categories in the Life Event section. For example, if the Employee clicks on Life Events they will see the listing of Life Events that the Employer has answered questions about. For example, “marriage” and “birth of child” might be listed. Then the Employee could click on marriage, and see the relevant questions listed by subcategory. I.e., The Salaried Employees' HMO Medical Plan may be one subcategory displayed, and all questions related to marriage and that medical plan would be listed under that subcategory.

All Subcategories for which a Question has been selected or entered by the Employer that the MyHROnline provider (or the Employer, in the case of Employer-entered Questions) have designated as being related to the Life Event would appear. If there were no Life Event questions answered for a particular Subcategory, that Subcategory would not be listed under that Life Event. Ex. “Joe's Body Shop 401k” might not be listed under “Birth of a Child” because no Question tied to “Birth” by the provider MyHROnline was selected by Joe and Joe did not designate any Employer-Entered Questions under that subcategory as being tied to “Birth.”

The Employer can control whether or not Life Events are listed on the Employee home page. An indicator on the Employer home page can denote the current status of the Life Event display. There can be a link to enable/disable Life Events next to the current status.

Search: On the Employee home page a search feature is available for employee use. This search would return a list of all Questions with respect to which the Questions or its Answers contain the specified text. This is a database search, not an HTML type search. The Employee may then click on any listed Question. After doing so, the Employee may return to the result list. For example, “coordination of benefits” would only return hits where “coordination of benefits” occurred as an entire text string in a Q or A. After viewing a Question on the results list, the Employee may click to return to the results list or click to enter a new search. Employee may not “Search” Life Events.

“Help” for Employee: A help system for the Employee can be programmed that will be similar in functionality to the help system for Employers, but it will have different text.

MyHROnline can provide a disclaimer on the first page of the Employee view describing what the system provides and indicating that if there is a difference between the information on the site and legal documents, the legal documents will prevail.

If an Employee is viewing a site that has gone live, but is now being updated, the employee log in page indicates that the site is not currently available and to try again later.

E-Mail Formats:

The text of the body of the e-mail formats below are provided as an example. The text may vary as specified by the provider of the MyHROnline system. For any esent to the Administrator (ADMIN), the Administrator can designate a separate Administrator e-mail addresses for one or more e-mail subjects. For example, the “cc” for “More Info” may go to ADMIN-moreinfo@arsalon.com. The Administrator e-mail addresses can be hard-coded.

The MyHROnline provider can change the category (i.e., To, From, cc or bcc) of any e-mail address in the examples below.

The “From” e-mail will receive the message only if it is included in another field, such as bcc. One embodiment of the system is designed such that all fields can be editable (except as noted below) except bcc. If that is the case, the Administrator should be a bcc on every e-mail below that it is to receive.

More Info on Vendor Products:

To: Vendor (Primary)

From: mail@myhronline.com

cc: Employer (Primary) Employer (secondary) Vendor (secondary); Administrator

bcc: None

Subject: [Employer Name] Interested in [Name of Benefit]

Body: [Employer Name] Interested in [Name of Benefit] [plus: hard-coded text supplied by MyHROnline provider].

Action that creates e-mail: Employer (ER) clicks on “More Info” button

Date to be sent: Immediate upon Employer clicking “send.”

Employer may “cancel” rather than send.

Delegate e-mail: Inform Employer of all 3 ealso tell Employer it will receive any undeliverable msg (not ADMIN), delegate will have full access, tell Employer its edit rights on the e-mail.

To: [Employer completes]

From: mail@myhronline.com)

cc: Administrator

bcc: None

Subject: [Employer name] requests assistance with MyHROnline

Body: [Please send e-mail to ER when you are done and ask them to login to view the results. ER must click to go live.] [will include link to MyHROnline with security embedded]. Include category, subcategory (if “delegate” was clicked at the subcategory or question level) and question (if “delegate” was clicked at the question level), info about why this e-mail was sent, request them to finish the red light(s) for that plan within 14 days, explain follow-up e-mails, explain that although it will have full access, it must limit its activity to help with the items requested.

Action that creates e-mail: Employer clicks on “Delegate” button, which will be displayed at each level: Benefit/Policy, Plan/Applicable Employee Group and Question.

Date to be sent: immediate upon Employer clicking “send.”

Employer may “cancel” rather than send.

Follow-up to Delegate: Employer will have to click “send.” The system will display to the Employer that “send” means the e-mail will be sent in 7 days.

To, From, cc, bcc (same as Delegate e-mail)

Subject: Follow-up on request for assistance with MyHROnline

Body: Display the following msg, then - - - and then include the body of the original e-mail (including link). “7 days ago, the following e-mail was sent to you, this message was automatically generated at that time. If you have not already completed your portion of the site, please do so now. Please ignore this e-mail if you have already completed your portion of the site.”

Action that creates e-mail: Employer clicks on “delegate.”

Date to be sent: 7 days after Employer clicks “send.”

Follow-up ER re: Delegation:

To: ER (Primary & Secondary)

cc: Delegate

bcc: None

From: ADMIN

Subject: Follow-up on delegate's task completion.

Body: Display the following message, then - - - and then include the body of the second e-mail (including link). “14 days ago you delegated completion of a portion of this site. 7 days we sent a follow-up message to the party to which you delegated this task. Please click on the link below and verify that this information is complete and accurate. If appropriate, and if all other information is finalized, please click “Go Live.” Please ignore this e-mail if you have already followed up on this task.

Action that creates e-mail: ER clicks on “delegate.”

Date to be sent: 14 days after ER clicks “send.”

Employer wants a consultant:

To: Consultant (as designated in the Vendor database for the Employer's Vendor)

From: mail@myhronline.com

cc: ADMIN (and Vendor, if Vendor requests add to Vendor database)

Subject: [Employer name] seeks consultant to set up MyHROnline

Body: [Please send e-mail to ER when you are done and ask it to login to view the results. ER must click to go live.] Link to MyHROnline page for Employer with security embedded. Include messages similar to delegate e-mail.

Action that creates e-mail: Employer clicks on “Consultant” button

Date to be sent: immediate upon Employer clicking “send.” Employer may cancel.

Follow-up to Consultant and Follow-up to ER re: consultant Similar to delegate follow-ups.

ADMIN-initiated e-mail to all Employers of either all Vendors or Vendors selected by Admin: Phases 1 and 2 will not include this function. However, the ER by Vendor report will include e-mails and they could be downloaded to a separate e-mail system.

Follow-up with Employer for update:

To: Employer (primary)

cc: Employer (secondary)

From: ADMIN

Subject MyHROnline follow up for [Employer Name]

Body: “When you selected or entered this Answer, you asked us to check with you on this date to see if the information you provided should be updated. If you have already updated this information please ignore the e-mail.” Include a link with embedded security to the web page in the Employer's Administration screens that is for the follow up item.

Action that creates: Employer clicks on “follow up” button with respect to an Answer and clicks “send on date requested” button

Date to be sent: to be supplied by Employer

Renewal First Warning: Don't send if ER charge=0 [Bill Vendors through separate billing software once per month.]

To: Employer (primary)

cc: Employer (secondary)

From: ADMIN

Subject: MyHROnline Renewal

Body: “We will charge $______ [system inserts $ amount] to your credit card” or “Please print this e-mail and return it with your check in the amount of $______ to: ______” (depending on how Employer paid in the first place) and a link to the Employer's home admin page with embedded security. “Please ignore if you have already paid.” Include Employer i.d., so ADMIN knows to whom to credit the check. There will be a link to ER Payment Management page so ER can change payment method.

Action that schedules e-mail: Employer initial enrollment or subsequent renewal

Date to be sent: Next expiration date, minus 60 days

Edit: No

Renewal (Second) Warning:

To: Employer (primary)

cc: Employer (secondary)

From: MyHROnline Provider

Subject: MyHROnline Renewal

Body: [“We will charge $______ [system inserts $ amount] to your credit card”] or [“Please print this e-mail and return it with your check in the amount of $______ to: ______”] (depending on how Employer paid in the first place) and a link to the Employer's home admin page with embedded security. “Please ignore if you have already paid.” Include Employer i.d., so ADMIN knows to whom to credit the check.

Action that creates e-mail: Employer initial enrollment or subsequent renewal

Date to be sent: Next expiration date, minus 30 days

Edit: No

Renewal Completed:

To: Employer (primary)

cc: Employer (secondary)

From: ADMIN

Subject: MyHROnline Renewal

Body: “Thank you. Your new expiration date is [______].”

Action that creates e-mail: ADMIN or the system changes renewal date for the Employer

Date to be sent: Immediate

Edit: No

Inactivation Notice:

To: Employer (primary)

cc: Employer (secondary)

From: ADMIN

Subject: MyHROnline account has been inactivated

Body: An Employee has attempted to view the site, but access was denied because your account has expired. Please renew your account or contact us to disable your site.

Action that creates e-mail: An EE or ER attempts to access the site and is denied access due to expiration.

Date to be sent: Immediate

Edit: No

To Vendor to set up EE link:

To: Vendor (primary)

From: Employer (primary), Employer (secondary)

cc: ADMIN, Vendor (secondary)

Subject: [Name of Employer] MyHROnline account

Body: “Please establish Employee link.” Versent will program to provide the vendor with all link info in the body of the e-mail, with Employer I.D embedded. ER may choose to also embed password. Therefore, an Employee clicking on the link from the Vendor's site will go directly to his/her Employer's MyHROnline site and can directly access the Employee view if the Employer did not designate a password for Employees or, if the Employer did specify a password for Employees, the system will ask for the password when the Employee links from Vendor.

Action that creates: This e-mail pops up after Employer clicks to “go live” or clicks to save change to Employer I.D. for Employee view, but only if the Vendor's database reflects that Vendor has requested this e-mail.

Date to be sent: Immediate, upon Employer clicking “send.” Employer may “cancel,” instead of sending it.

Thank-you e-mail and Employer Admin. URL:

To: Employer (primary)

cc: Employer (secondary)

From: Vendor, ADMIN

bcc: Vendor (secondary)

Subject: Thanks for purchasing MyHROnline

Body: Thank you. The following is a link to your ER Admin. Home page. Include Link embedded with username and password. Please log on to complete creation of your site for your employees.

Action that creates: Account activation

Date to be sent: Immediate

Edit: No

To ER to set up Employee link:

To: ER (primary & secondary)

From: ADMIN

cc: None

bcc: None

Subject: [Name of Employer] My HROnline site: Link to Employee View

Body: Similar to message to Vendor, except include instructions to Employer re: how to display link on intranet or other site. Includes URL to separately communicate to Employee.

Action that creates: This e-mail pops up after Employer clicks to “Go Live” or clicks to save change to Employer i.d. for Employee view.

Date to be sent: immediate, upon Employer clicking “send.” Employer may “cancel” instead of sending it.

Important Information: Part of the functionality of this button is that ADMIN may designate that for certain instances of its use, the Employer will be given the ability to send an e-mail from the ER's e-mail system (for example, to request legal review of something).

To: [ADMIN will define it may vary from IMP INFO button to IMP INFO button]

From: Employer (primary)

cc: Employer (secondary)

bcc None

Subject: [Employer Name] [Admin. will complete rest of subject this may vary by IMP INFO button to IMP INFO button]

Body: [Admin will define this may vary by IMP INFO button to IMP INFO button]

Action that creates: Employer clicks on “Important Info” and then clicks on “send e-mail” (the “send e-mail” button appears only if ADMIN designates that function for that Question's “Important Info.”)

Date to be sent: Immediate

Password to ADMIN:

To: MyHROnline Provider

From: ADMIN

cc:

bcc: None

Subject: ADMIN requests MyHROnline Password

Body: [Employee fills in his/her name] requests password

Action that creates: ADMIN requests it from its login screen.

Date to be sent: Immediate

Edit: No

Password to Employer:

To: Employer (primary)

From: ADMIN

cc ER (secondary)

bcc: None

Subject: [Employer name] My HROnline password

Body: You requested that we e-mail to you the password for your admin. The password is: ______.

Action that creates: Employer requests it from its login screen.

Date to be sent: Immediate.

Edit: No

Password to Employee:

To: Employer (primary)

From: ADMIN.

cc: Employer (secondary).

bcc: None.

Subject: [Employer Name] MyHROnline password for Employee

Body[Employee fills in], has requested your Employee view password. Please provide the following password to him or her: ______ [Hide this from Employee view].

Action that creates: Employee requests it from Employee login screen.

Date to be sent: Immediate

Edit: No.

The various online employee benefit communication examples shown above illustrate a novel method of communicating information to an employee. A user of the present invention may choose any of the above embodiment, or an equivalent thereof, depending upon the desired application. In this regard, it is recognized that various forms of the subject invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

1. A method for communicating via a wide area network employee benefit and policy information to an employee comprising the steps of:
providing on an employer website from a host server via a wide area network an expert pre-developed listing of Employee Benefit categories and related information from which an employer can select;
receiving employer selections from the pre-developed benefit categories and related information to the host server and formatting and storing the categories and related information selected on the employer website to an employee benefit website customized based on employer selections for access by employees via the wide area network;
launching the employee website; and
providing employees of the employer access to the formatted and stored categories and related information on the employee website for viewing where the employee can select specific categories and information to view.

2. The method for communicating via a wide area network as recited in claim 1 further comprising the steps:
providing on the employer website from a host server via the wide area network an expert pre-developed listing of Employee Policies/procedures and related information from which an employer can select;
receiving employer selections from the Policy categories and related information to the host server and formatting and storing the policy categories and related information selected on the employer website to an employee website customized based on employer selections; and
providing employees of the employer access to the formatted and stored policy categories and related information on the employee website for viewing where the employee can select specific categories and information to view.

3. The method as recited in claim 1 where providing an expert pre-developed listing includes providing pre-determined questions and answers grouped under and correlated to at least one benefit category.

4. The method as recited in claim 3 where providing an expert developed listing includes providing pre-determined questions and answers in pre-designated policies/procedures.

5. The method as recited in claim 3 where providing an expert pre-developed listing includes providing pre-determined questions and answers which may be correlated to a broader method of storing information such as a life event.

6. The method as recited in claim 1 where providing an expert pre-developed listing includes providing pre-determined questions and answers which may be correlated to a broader method of sorting information such as a life event.

7. The method as recited in claim 1 where receiving employer selections includes receiving employer selections of pre-determined questions and answers correlated to the selected benefit category.

8. The method as recited in claim 1 where receiving employer selections includes receiving names of plans offered by employer for the selected benefit category.

9. The method as recited in claim 1 where receiving employer selections includes receiving employer defined questions.

10. The method as recited in claim 1, further comprising the steps of:
loading forms and other documents to the employer site; and
providing a link to these forms/documents automatically in the answer via a special segment of code.

11. The method as related in claim 1 further comprising the step of:
providing on a secondary employer website from the host server via the Internet a secondary expert pre-determined listing of secondary Benefit categories and related information from which the employer can select.

12. A method for communicating via a wide area network employee benefit and policy information to an employee comprising the steps of:
providing on an employer website a user input platform from a host server via a wide area network operable to allow user to enter a customized listing of Employee Benefit categories and related information from which the employer can select and customize;
receiving employer selections from the customized employer benefit categories and related information to the host server and formatting and storing the categories and related information selected on the employer website to an employee website customized based on employer selections for access by employees;
launching the employee website; and
providing employees of the employer access to the formatted and stored categories and related information on the employee website where the employee can select specific categories of information.

13. The method for communicating as recited in claim 11, further comprising the steps of:
providing on an employer website a user input platform from a host server via a wide area network operable to allow user to enter a customized listing of Employee Policy categories and related information from which the employer can select and customize;
receiving employer selections from the customized employer policy categories and related information to the host server and formatting and storing the categories and related information selected on the employer website to the employee website customized based on employer selections for access by employees;
providing employees of the employer access to the formatted and stored categories and related information on the employee website where the employee can select specific categories of information.

14. A method for communicating via a wide area network employee benefit and policy information to an employee comprising the steps of:
presenting to an employer via a wide area network a computer generated display of an expert pre-developed selectable listing of Employee Benefit categories and related information;
allowing the employer to select Employee Benefit categories and related information presented on the computer generated display via an input media; and
allowing the employer to send selections to a host server for formatting and storing selections on an employer website to an employee website customized based on selections for access by employees via the wide area network.

15. The method for communicating employee benefit and policy information as recited in claim 13, further comprising the steps of:
presenting to the employer via the wide area network a second computer generated display of an expert pre-developed selectable listing of Employee Policy categories and related information;
allowing the employer to select Employee Policy categories and related information presented on the second computer generated display via the input media; and
allowing the employer to send selections to the host server for formatting and storing employee policy selections on the employer website to an employee website customized based on policy selections for access by employees via the wide area network.

16. The method for communicating employee benefit and policy information as recited in claim 13, where presenting an expert pre-developed listing includes presenting pre-determined questions and answers grouped under and correlated to at least one benefit category.

17. The method as recited in claim 15, where presenting pre-determined questions includes presenting questions in pre-designated Policies/procedures.

18. The method as recited in claim 15, where presenting an expert pre-developed listing includes presenting pre-determined questions and answers which may be correlated to a broader method of sorting information such as a live event.

19. The method as recited in claim 15, where allowing the employer to select includes allowing the employer to select pre-determined questions and answers correlated to the selected benefit category.

20. The method as recited in claim 15, where allowing the employer to send selections includes allowing the employer to send employer defined questions.

21. A method for communicating via a wide area network employee benefit and policy information to an employee comprising the steps of:
Presenting to an employer via a wide area network from a host server a computer-generated display of user input screens of a user input platform operable to allow a user to enter selections from predeveloped a customized listing of Employee Benefit categories and related information;
Presenting to the employer selections made from the customized employer benefit categories and related information via the computer generated display and presenting the formatted and the stored categories and related information selected on the employer website customized based on employer customized inputs and selections;
Launching an employee website; and
Presenting to the employee via an employee generated display providing employees of the employer access to the formatted and stored categories and related information and operable where the employee can select specific categories of information to view.

22. The method for communicating recited in claim 21 further comprising the steps of
Presenting to an employer via a wide area network from a host server a computer-generated display of user input screens of a user input platform operable to allow a user to enter selections from predeveloped a customized listing of Employee Policy categories and related information;
Presenting to the employer selections made from the customized employer policy categories and related information via the computer generated display and presenting the formatted and the stored categories and related information selected on the employer website customized based on employer customized inputs and selections;
Presenting to the employee via an employee generated display providing employees of the employer access to the formatted and stored categories and related information where the employee can select specific categories of information to view.

23. A method for communicating via a wide area network employee benefit and policy information to an employee comprising the steps of:
generating an expert pre-developed listing of Employee Benefit categories and related information and formatting and storing the categories and information on a server such that it is accessible via a wide area network to an employer;
establishing an employer log in session network link between the server and a computer interface of the employer and capturing employer selection of benefit categories;
processing employer selections and generating a customized employee website; and
launching the employee website accessible by employees.

24. The method for communicating employee benefit and policy information as recited in claim 23, where generating the listing includes generating predetermined questions and answers grouped under and correlated to at least one benefit category.

25. The method for communicating employee benefit and policy information as recited in claim 23, where capturing the employer selection includes capturing pre-determined questions and grouped under and correlated to at least one Life event.

26. The method for communicating employee benefit and policy information as recited in claim 23 where capturing employer selection includes capturing employer defined questions.

27. A method for communicating via the Internet employee benefit and policy information comprising the steps of:
Providing an input device and a plurality of computer generated displays from a server having prompts operable for initiating an employee inputting employee selections via the input device for a benefit category, plan, and question and said server operable to generate displays operable for displaying an answer based on the category, plan and question selected.

28. The method of claim 27 where providing displays is providing displays further having prompts operable for initiating an employee inputting employee selection for a life event for presenting employee information corresponding to the life event.

29. The method of claim 27 where providing displays is providing displays further having prompts operable for initiating an employee inputting employee selection for an Employee Grouping for presenting employee information corresponding to the employee grouping.

30. A computer program storage media readable by a computer having thereon computer instructions executable by the computer to perform a method for communicating via a wide area network employee benefit and policy information to an employee comprising the steps of:
providing from a host server via a wide area network an expert pre-developed listing of Employee Benefit categories and related information from which an employer can select;
receiving employer selections for benefit categories and related information to the host server and formatting and storing the categories and related information on an employer website to an employee website customized based on employer selections for access by employees via the wide area network;
launching the employee website; and
providing employees of the employer access to the formatted and stored categories and related information on the employee website for viewing where the employee can select specific categories and information to view.

31. The media having executable instructions as recited in claim 30, further comprising the steps of:
providing on the employer website from a host server via the wide area network an expert pre-developed listing of Employee Policies/procedures and related information from which an employer can select;
receiving employer selections from the Policy categories and related information to the host server and formatting and storing the policy categories and related information selected on the employer website to the employee website customized based on employer selections; and
providing employees of the employer access to the formatted and stored policy categories and related information on the employee website for viewing where the employee can select specific categories and information to view.

32. The media having executable instructions as recited in claim 30, further comprising the steps of:
providing on a secondary employer website from the host server via the Internet a secondary expert pre-determined listing of secondary Benefit categories and related information from which the employer can select.

33. A method for building via a wide area network a website for communicating employee benefit and policy information to an employee comprising the steps of:
Providing an input device and a plurality of computer generated displays having prompts operable for initiating a customer inputting via the input device a selection for a benefit category, plan, and question;
Selecting a benefit category having within the category a plurality of plans related to said category;
Selecting a plan having a plurality of questions related thereto from the plurality of plans related to the category;
Selecting a question having a plurality of answers related thereto, from the plurality of questions;
Selecting an answer from the plurality of answers; and
Providing a completion indication for the categories selected if a plan, question and answer have been selected or a non-completion indication if a plan, question or answer has not been selected.

34. The method of claim 33 further comprising:
Launching an employee website having all selections and accessible by employees.

35. A computer data signal embodied in an Internet protocol transmission session, comprising:
a code segment including instructions for providing an expert pre-developed listing of Employee Benefit categories and related information from which an employer can select;
a code segment including instructions for receiving employer selections for benefit categories and related information and for formatting and storing the categories and related information on an employer website to an employee website customized based on employer selections;
a code segment including instructions for launching the employee website; and
a code segment including instructions for providing employees of the employer access to the formatted and storing categories and related information on the employee website for viewing and where the employee can select specific categories and related information to view.

36. The computer data signal embodied in an internet protocol transmission as recited in claim 35, where the code segment including instructions for providing the listing further includes instructions for providing pre-determined questions and answers grouped under and correlated to at least one benefit category.

37. The computer data signal embodied in an internet protocol transmission as recited in claim 36, where the code segment including instructions for providing pre-determined questions, includes questions in pre-designated groupings based on employee groups.

38. The computer data signal embodied in an internet protocol transmission as recited in claim 36, where the code segment including instructions for providing pre-determined questions, includes questions correlated to at least one life event.

39. The computer data signal embodied in an internet protocol transmission as recited in claim 36, where the code segment including instructions for receiving employer selections includes instructions for receiving employer selections of predetermined questions correlated to the selected benefit category.

40. A method for building via the internet a website for communicating Employee Benefit and policy information to an employee comprising the steps of:
providing on an employer website from a host server via a wide area network an expert pre-developed listing of Employee Benefit categories and related information from which an employer can select;
receiving employer selections from the pre-developed benefit categories and related information to the host server and formatting and storing the categories and related information selected on the employer website to an employee benefit website customized based on employer selections for access by employees via the wide area network;
Steering employer inputs by prompting employer for the next input required and providing a completion indication when all necessary inputs have been made.

41. A network system for assembling and communicating employee benefit and policy information to an employee comprising:
a server accessible via a network having a code segment when executed provide via the network an expert pre-developed listing of Employee Benefit categories on related information from which an employer can select;
said server further having a code segment when executed receive employer selections for benefit categories and related information to the server and format and store the categories and related information for access by employees via the Internet; and
said server further having a code segment when executed provide employees of the employer access to the formatted and store categories and related information on the site for viewing where the employee can select specific categories and information to view.

42. The network system for assembling and communicating employee benefit and policy information as recited in claim 41, where the code segment when executed provide the listing further provide predetermined questions and answers grouped under and correlated to at least one benefit category.

43. The network system for assembling and communicating employee benefit and policy information as recited in claim 42, where the code segment when executed provide predetermined questions, further provide questions in pre-designated groupings based on employee groups.

44. The network system for assembling and communicating employee benefit and policy information as recited in claim 42, where the code segment when executed provide predetermined questions, further provide questions correlated to at least one life event.

45. The network system for assembling and communicating employee benefit and policy information as recited in claim 42, where the code segment when executed receive employer selections further receive employer selections of predetermined questions correlated to the selected benefit category.

46. A method for building via the internet a website for communicating Employee Benefit and policy information to an employee comprising the steps of:
providing on an employer website from a host server via a wide area network an expert pre-developed listing of Employee Benefit categories and related information from which an employer can select;
receiving employer selections from the pre-developed benefit categories and related information to the host server and formatting and storing the categories and related information selected on the employer website to an employee benefit website customized based on employer selections for access by employees via the wide area network; and
providing on the employer website functionality for sending task delegation email and follow-up email messaging.
